(19) United States
(12) Patent Application Publication
(10) Pub. No.: US 2005/0078598 A1
(43) Pub. Date: Apr. 14, 2005

(54) Enhancement to the multi-band OFDM physical layer

(76) Inventors: Anuj Batra, Dallas, TX (US); Srinivas Lingam, Richardson, TX (US); Jaiganesh Balakrishnan, Dallas, TX (US)

Correspondence Address: TEXAS INSTRUMENTS INCORPORATED, P O BOX 655474, M/S 3999, DALLAS, TX, 75265, US

(21) Appl. No.: 10/900,235

(22) Filed: Jul. 27, 2004

Related U.S. Application Data
(60) Provisional application No. 60/496,732, filed on Aug. 21, 2003.

(51) Int. Cl. H04J 11/00

(52) U.S. Cl. 370/206

(57) ABSTRACT

This specification describes several improvements to the Multiband OFDM (MB-OFDM) Physical Layer. A new PLCP frame format that better supports interoperability between 3-band and 7-band modes is described. An expanded PHY header is described with more reserved bits for future enhancements, an even number of OFDM symbols for the PLCP header that better supports time spreading and that the information is limited to just 2 OFDM symbols. A zero prefix is used to eliminate ripe in the transmitted spectrum so there is no back off required at the transmitter. A length 160 hierarchical sequence for the packet synchronization sequence is used to help eliminate the artificial side-lobe that is created during the correlation process at the receiver with the current length 128 hierarchical packet synchronization sequence.

### CLAIM TO PRIORITY OF PROVISIONAL APPLICATION

The application claims priority under 35 U.S.C. § 119(e)(1) of provisional application Ser. No. 60/496,732 entitled Enhancements to the MBOA Physical Layer Proposal, filed Aug. 21, 2003, by Anuj Batra, Srinivas Lingam and Jaiganesh Balakrishnan.

### BACKGROUND OF INVENTION

(1) Field of Invention

This invention relates generally to multiband OFDM systems for ultra wideband (UWB) applications, and more specifically to different aspects of the physical layer of a UWB system employing the Multi-band Orthogonal Frequency Division Multiplexing (MB-OFDM) and including one or more enhancements of physical layer such as in the frame format, the PHY header, the prefix of the OFDM symbol and the packet synchronization sequence.

(2) Description of the Related Art

The physical layer (PHY) definition of the multi-band OFDM has different parts like the PLCP (Physical Layer Convergence Protocol) Frame format, the PHY Header, the Cyclic Prefix of the OFDM waveform and the packet synchronization sequence.

PLCP Frame Format

FIG. 1 shows the PLCP (Physical Layer Convergence Protocol) frame format that was proposed in the Multi-band OFDM (MB-OFDM) physical layer proposal. In order to guarantee backwards compatibility between a 3-band system and a 7-band system (i.e. all devices could detect the preamble and decode the header), the PLCP preamble and the PLCP header are transmitted using just the 3-band mode. For the 7-band mode, additional channel estimation sequences are also transmitted so that the receiver can estimate the frequency-domain channel impulse response of the upper 4 channels. These additional channel estimation sequences are interleaved with the PLCP header (the PLCP header is transmitted on the first 3 bands and the channel estimation sequences are transmitted on the upper 4 bands). FIG. 2 shows an example of the interleaving between the PLCP header and the additional channel estimation sequences.

One of the drawbacks of this approach is that the state machine for the receiver has to be different depending on whether the system is receiving a packet in a 3-band mode or in a 7-band mode. In addition, information needs to be transmitted before the PLCP header in order to indicate to the receiver that it should either stay in a 3-band mode or switch to a 7-band mode. The only place where this information could possibly be transmitted is in the frame synchronization (end of synchronization) section of the preamble. The proposed method in the MB-OFDM proposal by the MBOA Special Interest Group is to modulate the frame synchronization sequences with a pattern. In FIG. 2, the pattern is defined as[p4,p5,p6]. A problem that may occur with this approach is that if one of the bands has a poor signal-to-noise ratio (SNR) or if there is an interferer present, then it is possible that the modulated pattern on the frame synchronization sequence may be missed by the receiver, resulting in a packet error.

PHY Header

The current PHY header, shown in FIG. 3, consists of only 18 bits of information including two reserved bits. The information specifying if the packet is transmitted using the 3-band mode or 7-band mode requires the use of one of the reserved bits leaving just one reserved bit which severely limits the options for future extensions. In conjunction with the Media Access Control layer (MAC) header, HCS (Header Checksums), and tail bits, the total PLCP header consists of a total of 7 OFDM symbols. The PLCP header format of 7 OFDM symbols is incompatible with the time-spreading option which requires an even number of OFDM symbols.

Cyclic Prefix

The OFDM symbols in the current MB-OFDM proposal are created by cyclically extending the last 32 samples of the 128-point Inverse Fast Fourier Transform (IFFT) output and pre-appending these samples to the beginning of the IFFT output. FIG. 4 shows this cyclic extension.

This cyclic extension introduces structure into the OFDM symbol and correspondingly the transmitted waveform resulting in ripples in the transmitted power spectral density (PSD). As the Ultra Wide Band (UWB) system is average power spectral density limited, these ripples in the transmitted spectrum will require additional back-off at the transmitter. This back-off will result in a reduction of the overall transmitter power. FIG. 5 illustrates the power density plots for an MB-OFDM system using the Cyclic Prefix. The dark area at the top represents the ripples. It has been found, via Matlab simulations, that the required backoff for the current MB-OFDM system can be as high as 1.3 dB. This would effectively mean that the transmitter needs to back-off by as much as 1.3 dB, which would result in 1.3 dB loss in overall range.

Packet Synchronization Sequence

FIG. 6 shows the structure of the current packet synchronization sequence. This sequence is created by cyclically extending a hierarchical sequence. The hierarchical sequence is created by spreading a length 16 bi-phase sequence with a length 8 bi-phase sequence. Note that the resulting packet synchronization sequence maintains the same functional structure as an OFDM symbol.

Cyclically extending the hierarchical sequence has one major drawback. When correlating with this sequence at the receiver, we artificially create a side-lobe plus or minus #128 samples away from the main peak. This side-lobe can have an impact on the packet detection mechanism especially in noise and multi-path limited scenarios and could potentially lead to false or missed detection.

### SUMMARY OF INVENTION

In accordance with one embodiment of the present invention a new PLCP format with a band extension field keeps the PLCP preamble and PLCP header the same for both a 3-band mode and a 7-band mode and thus better supporting the interoperability between the 3-band mode and the 7-band mode and future extensions, such as MIMO and advanced coding.

In another aspect of the embodiment the information that conveys whether the device should stay in the 3-band mode or switch to a 7-band mode is embedded into the PLCP header, which is more reliable.

In accordance with another embodiment of the present invention a new expanded PHY header has been proposed that includes more reserved bits for future enhancements and also has an even number of OFDM symbols for the PLCP Header which better supports time-spreading and fits the structure of the interleaver.

In another embodiment of the present invention the PHY Header information bits are located in the beginning portion of the first six (6) OFDM symbols (the size of the interleaver), which reduces the latency and helps to meet the timing needed to switch to the 7-band extension.

In accordance with another embodiment of the present invention, a zero prefix that corresponds to appending 32 zero samples before the output of the IFFT has been defined. Additionally, the time corresponding to the zero prefix and guard interval can be incorporated into the pulse repetition interval, implying an increase in overall transmitted power by 1 dB.

In accordance with yet another embodiment of the present invention a new packet synchronization sequence by the use of a length 160 hierarchical sequence so that there will not be any artificial side-lobes. The length of the packet synchronization sequence is the same so that there will be not changes in terms of the PRI rate.

In accordance with another embodiment of the present invention is another new format for the packet synchronization sequence by pre-appending a zero prefix of length 32 to the original 128 length hierarchical sequences to generate a 160 length packet synchronization sequence.

### DESCRIPTION OF DRAWING

FIG. 1 illustrates the prior art current MB-OFDM proposal PLCP frame format.

FIG. 2 illustrates current prior art proposed interleaved PLCP header and channel estimation sequences for the 7-band mode.

FIG. 3 illustrates the current prior art MB-OFDM proposal PHY header bit assignment.

FIG. 4 illustrates the prior art cyclic extension to create the OFDM symbol.

FIG. 5 illustrates power spectral density plot for an MB-OFDM system using a Cyclic Prefix.

FIG. 6 illustrates the current proposed prior art packet synchronization sequence format.

FIG. 7 illustrates the PLCP frame format according to one embodiment of the present invention.

FIG. 8 illustrates the PLCP frame format according to one embodiment of the present invention in the time-domain for a 7-band mode.

FIG. 9 illustrates the PHY header bit assignment according to one embodiment of the present invention.

FIG. 10 illustrates zero-padded prefix according to one embodiment of the present invention.

FIG. 11 illustrates power spectral density plot for an MB-OFDM system using zero-padded prefix according to one embodiment of the present invention.

FIG. 12 is a block diagram for the generation of the length of 160 hierarchical sequences according to one embodiment of the present invention.

FIG. 13 illustrates packet synchronization according to another new format with a zero prefix.

FIG. 14 illustrates a zero-padded prefix according to one embodiment of the present invention.

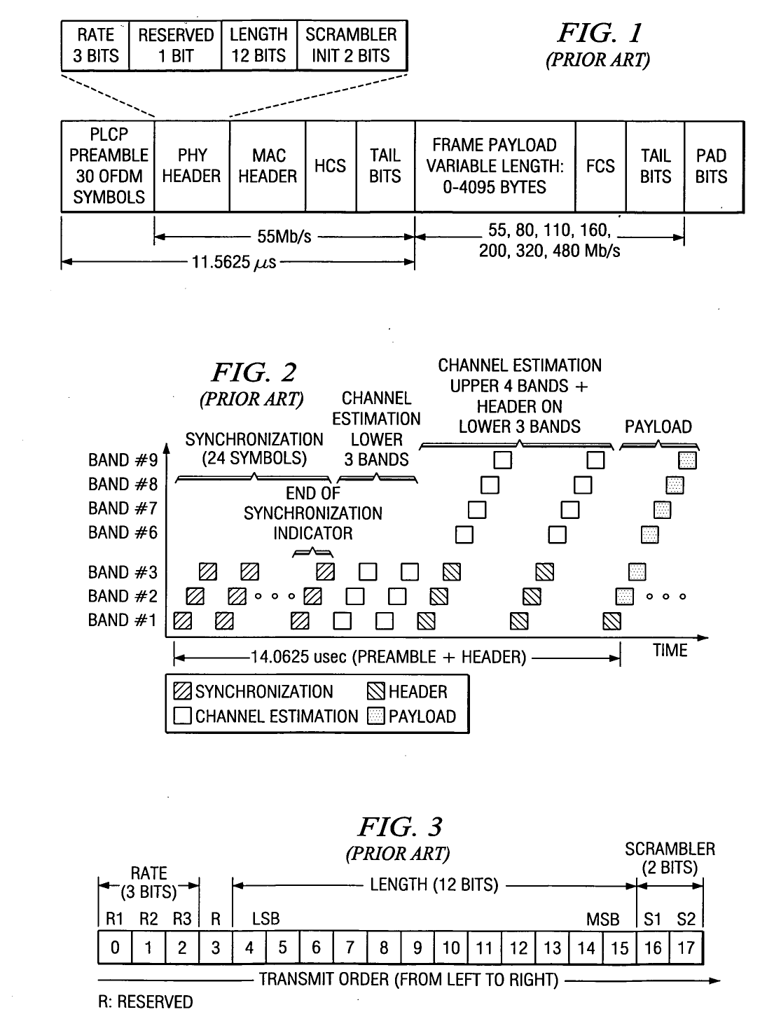

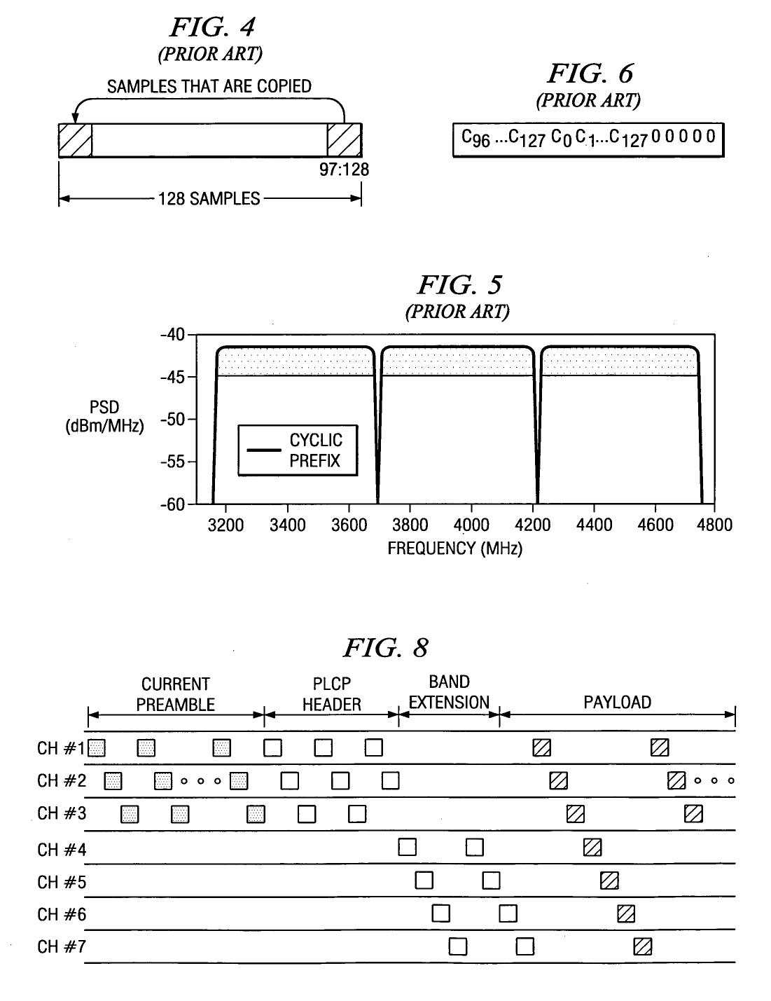

### DETAILED DESCRIPTION OF PREFERRED EMBODIMENTS

New PLCP Frame Format

In view of the above drawbacks in the prior art PLCP Frame Format discussed in the background, it is desirable to keep the PLCP preamble and PLCP header the same in both the 3-band and 7-band modes, thereby simplifying the state machine in the receiver. Additionally, the information indicating if the packet is in the 3-band mode or the 7-band mode can be embedded in the PLCP header, thereby improving the decoding performance of this information and reducing the packet errors.

A first modification made to the PLCP frame format is to keep the PLCP preamble and the PLCP header the same for both the 3-band mode and the 7-band mode. The advantage is that this simplifies the state machine for the receiver and ensure backwards compatibility with legacy devices.

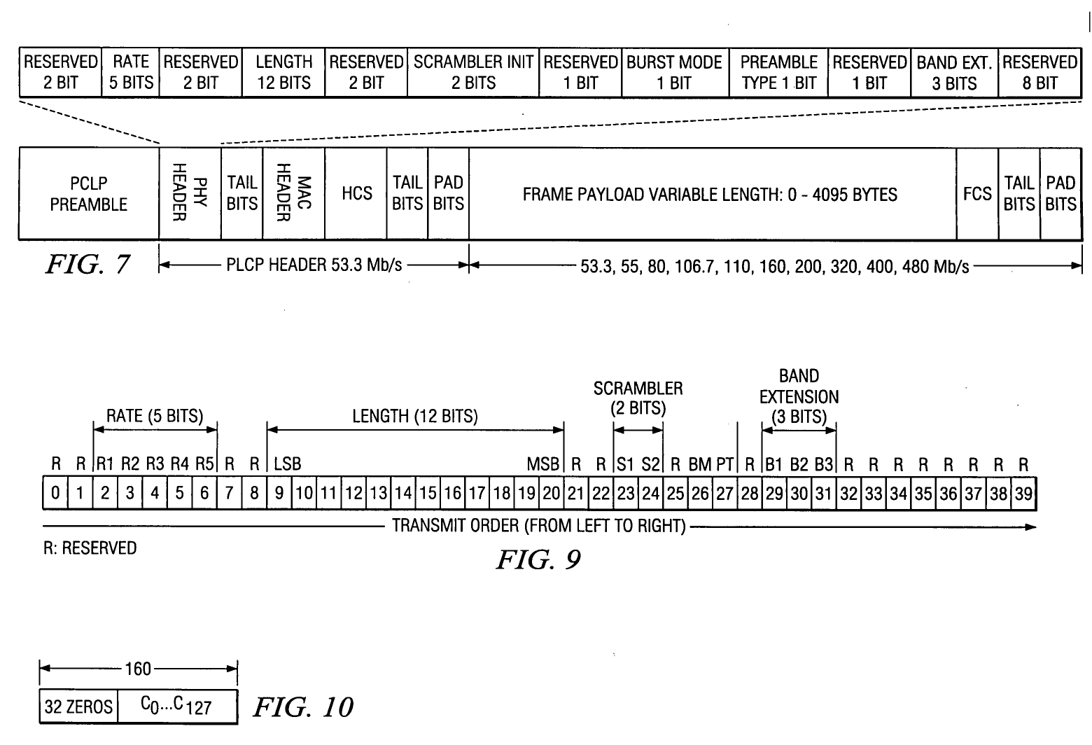

A second new teaching according to one embodiment of the present invention is adding an extension bits field for various extensions of the MB-OFDM physical layer. These extension bits in the Header can be used to identify the features of the packet including band extension, for specifying data rates less than the current proposed 55 Mb/s and rates above 480 Mb/s and/or specifying information regarding possible different MIMO (Multiple Input Multiple Output) modes of the system or possible advanced coding schemes. For the case where the extension bits are for band extension these extension bits are added to keep the PLCP preamble and PLCP header the same for both a 3-band mode and a 7-band mode. In addition, the information that conveys whether the device should stay in the 3-band mode or switch to a 7-band mode (and expect additional channel estimation sequences) is now embedded into the header, where it can be more reliably decoded. A block diagram of the new PLCP frame format according to one embodiment of the present invention is shown in FIG. 7. This figure shows that there is a three bit field, called the extension field, which indicates whether the device should stay in a 3-band mode or switch to a 7-band mode. By allocating three bits, we are also allowing for future expansion into more bands, such as an 11-band mode. Also as mentioned previously the extension field can also be used to indicate low data rates and/or MIMO modes of the system and advanced coding schemes.

A consequence of embedding the band extension information into the PHY header is that the number of OFDM symbols describing the PLCP header has increased from 7 to 12. Note that an additional OFDM symbol only increases the overall PLCP header length by 312.5 ns. This additional time should not result in any significant change in throughput. A benefit of increasing the number of OFDM symbols in the PLCP header is that the number of reserved bits in the PHY header can now be increased. Having additional reserved bits will allow for a graceful expansion of the IEEE 802.15.3a standard. Additional information on the exact structure of the PHY header will be discussed later in this patent description.

An additional benefit of the new PLCP header consisting of 12 OFDM symbols is that it is more amenable to time-spreading and fits the structure of the interleaver. Time-spreading is an idea where information is spread in time by repeating the same information in two consecutive OFDM slots. Note that repeating the information does not imply that the same OFDM symbol is transmitted twice. It just means that the same information is contained in both OFDM symbols. One example could be that the second OFDM symbol is a time-reversed version of the first OFDM symbol. The current MB-OFDM proposal uses frequency-domain spreading, but it can also use time-domain spreading, or time-spreading.

An example of the proposed PLCP frame format in the time-domain for the 7-band mode is illustrated in FIG. 8. Channels 1-3 represent the three low band channels and the channels 4-7 represent the 4 high bands. The proposed preamble in FIG. 8 contains synchronization symbols and the channel estimation symbols for the lower three bands as in the current OFDM proposal presented in FIG. 2. In accordance with the present invention the entire PLCP header follows on the lower three bands followed by the band extension containing the channel estimation symbols for the upper bands (Channels 4-7) and we teach to decode the PHY header bits before we go to the other higher bands.

An additional modification that is made to the PLCP header is that an additional six (6) tail bits B are added after the PHY header A in FIG. 7. A block diagram of the new PLCP frame format according to one embodiment of the present invention is shown in FIG. 6. The advantage of adding these tail bits is to flush the memory of the convolutional decoder after receiving the PHY header and ensuring that the PHY header can be decoded separately from the MAC header. This makes it easier for the system to meet the latency requirements. Note that the latency is an important issue that is considered in this design, because the extension bits must be decoded in time in order to tell the radio to start tuning to the upper four frequencies. If these bits are not decoded on time, then the receiver will not be able to properly receive the additional channel estimation sequences and therefore, will not have the correct frequency-domain channel impulse response for the upper four bands.

New PHY Header

In view of the above issues discussed in the background under the PHY Header, it is desirable to increase the number of information bits in the PHY header including the reserved bits and also increase and make the number of OFDM symbols even and ensure that the header is aligned on the interleaver boundary.

A new proposed PHY header according to one embodiment of the present invention is shown in FIG. 9. This new header allows the transmitter to provide additional information data rates (5 bits instead of 3 bits) and also the transmitter to provide information to the receiver of any extensions including specifying using a 3-band more or a 7-band or a different band mode. The extension field can also be used for specifying data rates less than the current proposed 55 Mb/s and rates above 480 Mb/s and/or specifying information regarding possible MIMO (Multiple Input Multiple Output) modes of the system and advanced coding schemes.

Bits 0, 1, 7, 8, 21, 22, 25, 28, and 32-39 of the PHY header are reserved for future use. Bits 29-31 shall encode the EXTENSION field. Bits 2-6 shall encode the RATE. Bits 9-20 shall encode the LENGTH field, with the least significant bit (LSB) being transmitted first. Bits 23-24 shall encode the initial state of the scrambler, which is used to synchronize the descrambler of the receiver.

Depending on the information data rate (RATE), the bits R1-R5 shall be set according to the values in Table 1.

TABLE 1
Rate-dependent parameters

| Rate (Mb/s | R1-R5 |
|---|---|
| 53.3 | 00000 |
| 80 | 00001 |
| 106.7 | 00010 |
| 160 | 00011 |
| 200 | 00100 |
| 320 | 00101 |
| 400 | 00110 |
| Reserved | 01000-11111 |

The PLCP Length field shall be an unsigned 12-bit integer that indicates the number of octets in the frame payload (which does not include the FCS, the tail bits, or the pad bits). The bits S1-S2 shall be set according to the scrambler seed identifier value. This two-bit value corresponds to the seed value chosen for the data scrambler. The Extension field shall be set according to the values in Table 2.

TABLE 2
Rate-dependent parameters

| Extension | B1-B3 |
|---|---|
| 3-Band | 000 |
| 7-Band | 001 |
| Reserved | 010-111 |

There is also a Burst Mode bit (BM bit) and Preamble Type bit (PT bit). The BM bit (0=next packet is not part of the burst mode, 1=next packet is part of the burst mode) is used to indicate to the receiver the next packet will be part of the burst. This helps configure the hardware quickly in order to properly receive the next frame. In addition, the Preamble Type bit (0=long preamble, 1—short preamble) tells the receiver the type of preamble (short or long) that will be used in the next burst packet. This again is needed in order to quickly set up the hardware.

New Prefix

In view of the problems discussed in the background with the cyclic prefix it is desirable to remove the cyclic prefix and use a zero prefix which removes the structure in the OFDM symbol and the transmitted waveform.

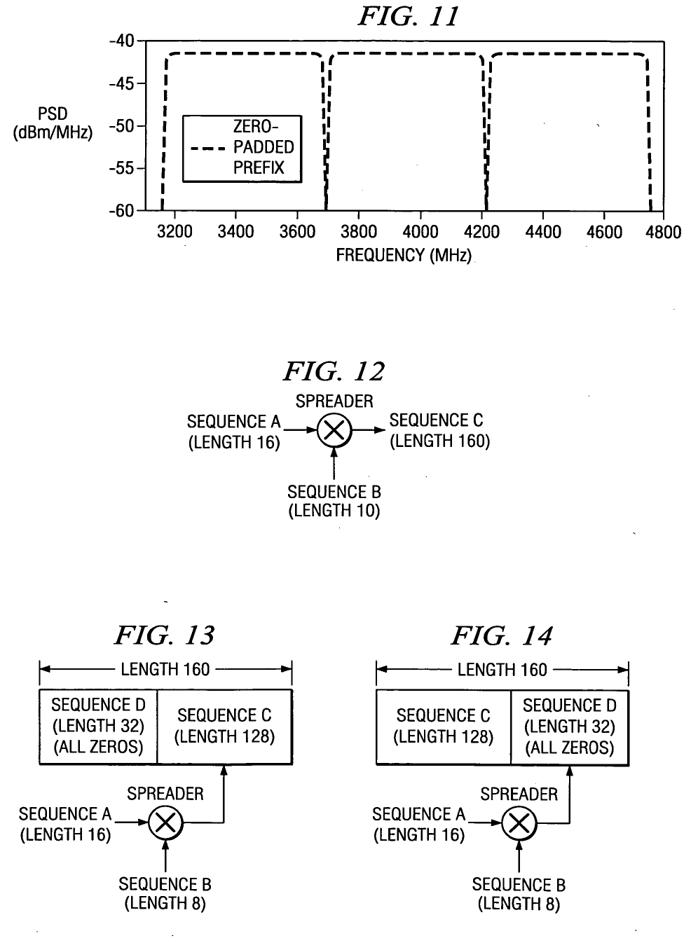

It is proposed herein that a zero-padded prefix (ZPP) will work as well as a cyclic prefix in OFDM-based systems. See B. Muquet et al., “Cyclic Prefix or Zero Padding for Wireless Multicarrier Transmission?”, IEEE Transactions on Communications, vol. 50, no. 12, December 2002. A zero prefix corresponds to appending 32 zero samples before the output of the IFFT. See FIG. 10. The only modification at the receiver is to collect additional samples corresponding to the length of the prefix and to use an overlap-and-add method to restore the circular convolution property. The advantages of a zero prefix are as follows:
1) When zero-padded prefix (ZPP) is used, the structure in the transmitted signal is eliminated resulting in a flat power density plot as illustrated in FIG. 11.
2) The power consumption at the transmitter can be reduced because the power required to transmit a cyclic prefix is no longer needed.
3) In addition, a higher transmitter power can be used when there is a zero cyclic prefix. The reason for this is because the time span for the zero prefix can be incorporated into the pulse repetition interval (PRI). The additional time increase in the PRI will result in an additional 0.97 dB of transmit power.
4) Using a zero prefix instead of the cyclic prefix removes the structure in the OFDM symbol and the transmitted waveform. As a result, the ripples in the transmitted spectrum are non-existent. This means that the 1.3 dB back-off required in transmit power when using a cyclic prefix is no longer needed for the case when the system uses a zero prefix.

It is also proposed herein that a zero-padded postfix (ZPP) can be used with all the advantages that are seen with a zero-padded prefix. A zero-padded postfix corresponds to appending 32 zero samples after the output of the IFFT. See FIG. 14. The only modification at the receiver is to collect additional received samples corresponding to the length of the postfix and to use an overlap-and-add method to restore the circular convolution property. The advantages of a zero-padded postfix are similar to the advantages of a zero-padded prefix. The zero-prefix and/or zero-postfix can be of length 32 or 37. When we use 37, we eliminate the guard interval.

New Packet Synchronization Sequence

In view of the issue presented in the background of the invention, it is desirable to use a packet synchronization sequence that has no significant side-lobe characteristics. Removing the artificial side-lobes created due to the correlation could significantly help in packet detection.

It is proposed herein to use a length 160 hierarchical sequence instead of the cyclically extended 128 length hierarchical sequence. The advantage of a 160 length sequence is that there will not be any artificial side-lobes. In addition, the length of the two packets synchronization sequence is the same so that there will be not be changes in terms of the PRI rate.

The length 160 hierarchical sequences are created by spreading a length 16 bi-phase sequence with a length 10 bi-phase. These sequences are known to have the minimum peak side-lobes. A diagram showing how to create the length 160 hierarchical sequences is shown in FIG. 12.

Sequence A and B are enumerated in Table 3 and Table 4.

TABLE 3
Sequence A

| Preamble | | | | | | | | | | | | | | | | |
|---|---|---|---|---|---|---|---|---|---|---|---|---|---|---|---|---|
| Pattern | Sequence A | | | | | | | | | | | | | | | |
| 1 | −1 | −1 | 1 | −1 | 1 | −1 | −1 | 1 | 1 | −1 | −1 | −1 | −1 | −1 | 1 | 1 |
| 2 | −1 | 1 | 1 | −1 | 1 | −1 | 1 | 1 | −1 | −1 | 1 | 1 | 1 | 1 | 1 | −1 |
| 3 | −1 | 1 | −1 | −1 | 1 | −1 | −1 | −1 | 1 | −1 | −1 | −1 | 1 | 1 | 1 | 1 |
| 4 | −1 | 1 | 1 | −1 | 1 | 1 | 1 | −1 | 1 | 1 | 1 | −1 | −1 | −1 | −1 | 1 |

TABLE 4
Sequence B

| Preamble | | | | | | | | | | |
|---|---|---|---|---|---|---|---|---|---|---|
| Pattern | Sequence B | | | | | | | | | |
| 1 | 1 | −1 | −1 | 1 | −1 | −1 | −1 | 1 | 1 | 1 |
| 2 | 1 | −1 | −1 | 1 | −1 | −1 | −1 | 1 | 1 | 1 |
| 3 | 1 | 1 | 1 | −1 | −1 | −1 | 1 | −1 | −1 | 1 |
| 4 | 1 | 1 | 1 | −1 | −1 | −1 | 1 | −1 | −1 | 1 |

The reason for sticking with a hierarchical sequence as the basis of the packet synchronization sequence is that there is an efficient implementation for the correlator. The correlator is typically used for packet detection at the receiver. Since the receiver will be in a listening mode (i.e. packet detection) for a significant portion of its operation, we need to use efficient algorithms that result in low power consumption.

In addition, we have also specified 4 different preambles. These preambles were chosen so as to minimize the peak cross-correlation. By choosing low cross-correlation properties, it will be easier for the devices to distinguish between the different piconets. Also, the individual sequences were chosen so that each sequence has good auto-correlation properties. The reason for choosing different preambles for different piconets is to be able to differentiate between the piconets via the preamble alone.

Additional New Formats:

It is possible to use the idea of a zero prefix to generate another packet synchronization sequence. The idea is to use the original 128 length hierarchical sequences and pre-appending a zero prefix of length 32 to generate a 160 length packet synchronization sequence. The advantage of this approach is that the packet synchronization sequence is consistent with the structure of a zero prefix OFDM symbol. In addition, the transmit power can be approximately 1 dB higher, due to the fact that the zero prefix can now extend the PRI.

Also it is possible to use a zero postfix to generate another packet synchronization sequence. The idea is to use the original 128 length hierarchical sequences and append 32 zeros to generate a 160 length packet synchronization sequence.

1. A physical layer convergence protocol (PLCP) frame format for the multi-band OFDM physical layer for an ultra wideband system comprising:
a PLCP header and
an optional extension.

2. The PLCP frame format of claim 1 wherein the PLCP header comprises of:
a PHY header;
tail bits after the PHY header to flush the memory of the convolutional encoder to ensure that the PHY header can be decoded separately from a MAC header and that the latency requirements can be met by the system;
said MAC header followed by the HCS bits which are in turn followed by additional tail bits and pad bits after a second set of tail bits to ensure that there are sufficient information to ensure the PLCP header is encoded in an integer number of OFDM symbols and a multiple of 6.

3. The PLCP frame format of claim 1 wherein there are six (6) tail bits after the PHY header.

4. The PLCP frame format of claim 3 wherein there are 6 tail bits inserted after the MAC header and HCS field and there are sufficient pad bits added to ensure that the PLCP header is transmitted with an even number of OFDM symbols and the PLCP aligns on an interleaver boundary or multiple of 6 ODFM symbols.

5. A physical layer convergence protocol (PLCP) frame format for ultra wideband system comprising:
a PHY header and
tail bits after the PHY header to flush the memory of the convolutional encoder to ensure that the PHY header can be decoded separately from the MAC header and that the latency requirements can be met by the system.

6. The PLCP frame format of claim 5 wherein there are six (6) tail bits after the PHY header.

7. A physical layer convergence protocol (PLCP) frame format to support different modes for ultra wideband system comprising:
a PLCP preamble to support the different modes and a PHY header comprising extension field bit is for the different modes.

8. The PLCP frame format of claim 7 wherein said PLCP includes tail bits after the PHY header to flush the memory of the convolutional encoder to ensure that the PHY header can be decoded separately from the MAC header and that the latency requirements can be met by the system.

9. The PLCP frame format of claim 7 wherein said different modes are one of band extension modes, low data rate modes, multiple input-multiple output (MIMO) modes, additional high data rate modes or advanced coding.

10. The PLCP frame format of claim 7 wherein said difference modes are a combination of two or more of band extension modes, low data rate modes, additional high data rate modes, MIMO modes, and advanced coding modes.

11. The PLCP frame format of claim 7 wherein said band extension modes range from 3-bands to 7-bands.

12. The PLCP frame format of claim 11 wherein said frame format supports data rates modes below 55 Mbps.

13. The PLCP frame format of claim 11 wherein said frame format supports data rates modes above 480 Mbps.

14. The PLCP frame format of claim 11 wherein said frame format can support MIMO modes that support additional preamble types and packet formats for multiple transmit and multiple receiver antenna modes or combinations.

15. The PLCP frame format of claim 11 wherein said frame format can support advanced coding modes.

16. A physical layer convergence protocol (PLCP) frame format to support interoperability between 3-band and 7-band modes comprising:
a PLCP preamble that is the same for both 3-band and 7-band modes;
a PHY header comprising three bit band extension field wherein the three bit band extension field indicates whether the device should stay in a 3-band mode or switch to a 7-band mode.

17. The PLCP frame format of claim 16 including said PLCP includes tail bits after the PHY header to flush the memory of the convolutional encoder to ensure that the PHY header can be decoded separately from the MAC header wherein all of the PLCP header is transmitted on lower bands before channel estimation is transmitted on higher bands and that the latency requirements can be met by the system.

18. The PLCP frame format of claim 16 including an expanded header with more reserved bits for future enhancements, an even number of OFDM symbols for the PLCP header and the information corresponding to the PHY header, which is contained within the first 6 OFDM symbols.

19. A PHY header comprising:
bits 0,1,7,8,21,22,25, 28 and 32-39 are PHY reserved bits for future use;
bits 29-31 encode band extension field;
bits 2-6 encode the rate;
bits 9-20 encode the length field, with least significant bit (LSB) being transmitted first; and
bits 23-24 encoding an initial state of the scrambler, which is used to synchronize the descrambler at the receiver.

20. The PHY header of claim 19 including bit 26 is a bit mode bit used to indicate to the receiver the next packet will be part of the burst.

21. The PHY header of claim 20 including bit 27 is a Preamble Type bit used to indicate to the receiver the type of preamble (short or long) that will be used in the next burst packet.

22. The PHY header of claim 19 including bit 27 is a Preamble Type bit used to indicate to the receiver the type of preamble (short or long) that will be used in the next burst packet.

23. A physical layer convergence protocol (PLCP) frame format to support interoperability between 3-band and 7-band modes comprising:
a PLCP preamble that is the same for both 3-band and 7-band modes;
a PHY header comprising three bit band extension field wherein the three bit band extension field indicates whether the device should stay in a 3-band mode or switch to a 7-band mode;
tail bits after the PHY header to flush the memory of the convolutional encoder to ensure that the PHY header can be decoded separately from the MAC header wherein all of the PLCP header is transmitted on low channel before channel estimation is transmitted on higher bands and that the latency requirements can be met by the system;
an expanded header with more reserved bits for future enhancements, an even number of OFDM symbols for the PLCP header and the information corresponding to the PHY header, which is contained within the first 6 OFDM symbols.

24. The PLCP of claim 23 wherein
bits 0,1,7,8,21,22,25, 28 and 32-39 are PHY reserved bits for future use;
bits 29-31 encode band extension field;
bits 2-6 encode the rate;
bits 9-20 encode the length field, with least significant bit (LSB) being transmitted first; and
bits 23-24 encoding an initial state of the scrambler, which is used to synchronize the descrambler at the receiver.

25. An ODFM symbol comprising:
a zero prefix of 32 or 37 zero samples before 128 sample output of the IFFT.

26. An ODFM symbol comprising:
a zero postfix of 32 or 37 zero samples appended to the IFFT output.

27. A method of preventing ripples in the power spectral density comprising the step of providing ODFM symbols by appending 32 or 37 zero samples before the 128 sample output from the IFFT.

28. A method of preventing ripples in the power spectral density comprising the step of providing ODFM symbols by appending 32 or 37 zero samples after the 128 sample output from the IFFT.

29. An improved packet synchronization preamble method to remove artificial sidelobes at the receiver when correlating the packet synchronization sequence comprising the steps of providing a 160 or 165 hierarchical sequence.

30. The method of claim 29 wherein the length of 160 hierarchical sequences is provided by is provided by spreading a length 16 bi-phase sequence with a length 10 bi-phase sequence.

31. The method of claim 29 wherein the original 128 hierarchical sequences provided by spreading a length 16 bi-phase sequences with a length 8 bi-phase sequence is pre-appended by a zero prefix of length 32 or 37 zeros to generate a 160 or 165 length packet synchronization sequence.

32. The method of claim 29 wherein the original 128 hierarchical sequences provided by spreading a length. 16 bi-phase sequences with a length 8 bi-phase sequence is appended by a zero prefix of length 32 or 37 zeros after the preamble to generate a 160 or 165 length packet synchronization sequence.

33. A multiband OFDM physical layer for ultra wideband system comprising:
a packet synchronization sequence of 160 hierarchical sequences;
ODFM symbols having appended 32 zero samples before 128 sample output from an inverse fast Fourier transform;
a PLCP preamble that is the same for both 3-band and 7-band modes;
a PHY header comprising three bit band extension field wherein the three bit band extension field indicates whether the device should stay in a 3-band mode or switch to a 7-band mode;
tail bits after the PHY header to flush the memory of the convolutional encoder to ensure that the PHY header can be decoded separately from the MAC header wherein all of the PLCP header is transmitted on low channel before channel estimation is transmitted on higher bands and that the latency requirements can be met by the system;
an expanded header with more reserved bits for future enhancements, an even number of OFDM symbols for the PLCP header and the information limited to just 2 OFDM symbols.

34. The PHY layer of claim 33 wherein said wherein the length of 160 or 165 hierarchical sequences is provided by is provided by spreading a length 16 bi-phase sequence with a length 10 bi-phase sequence.

35. The PHY layer of claim 34 wherein said 160 hierarchical sequences are created by adding a 32 length zero prefix before the original 128 length hierarchical sequence.

36. The PHY layer of claim 34 wherein said 160 hierarchical sequences are created by appending a 32 length zero postfix after the original 128 length hierarchical sequence.

37. The PHY layer of claim 34 wherein said 165 hierarchical sequences are created by adding a 37 length zero prefix before the original 128 length hierarchical sequence.

38. The PHY layer of claim 34 wherein said 165 hierarchical sequences are created by appending a 37 length zero postfix after the original 128 length hierarchical sequence.
